(19) United States
(12) Patent Application Publication
(10) Pub. No.: US 2024/0317921 A1
(43) Pub. Date: Sep. 26, 2024

(54) Compositions for forming polyureas, methods of forming polyureas and kits for forming polyureas

(71) Applicant: Richard John Foster, Bromyard Hereford and Worcester (GB)

(72) Inventor: Richard John Foster, Bromyard Hereford and Worcester (GB)

(21) Appl. No.: 18/278,764

(22) PCT Filed: Feb. 16, 2022
(86) PCT No.: PCT/GB2022/050408

§ 371 Date: Aug. 24, 2023

(30) Foreign Application Priority Data
Feb. 25, 2021 (GB) 2102682.8

(51) Int. Cl. C08G 18/32; C08G 18/08

(52) U.S. Cl. CPC C08G 18/3259; C08G 18/0852; C08G 2150/00

(57) ABSTRACT

The present invention relates to compositions for forming polyureas. The present invention also relates to methods of forming polyureas. The present invention also relates to kits for forming polyureas.

### FIELD OF THE INVENTION

The present invention relates to compositions for forming polyureas. The present invention also relates to methods of forming polyureas. The present invention also relates to kits for forming polyureas.

### BACKGROUND OF THE INVENTION

Polyureas, for example polyurea coatings, are typically made with high viscosity components that require inclusion of large amounts of solvent to lower the viscosity so that the components are at a usable consistency. Known solvents for inclusion with high viscosity components include methyl proxitol acetate, butyl acetate, methyl isobutyl ketone, xylene and dibasic ester.

One example of a polyurea (in particular, a two-component concrete primer) is Sika® concrete primer, as currently sold by Sika®. Sika® concrete primer is a two component, rapid curing, high solids, solvent based polyurea primer. Sika® concrete primer is used as a bonding agent on cementitious substrates. Sika® concrete primer seals and primes substrates within approximately 30 minutes (depending on temperature, humidity and pressure conditions). Sika® concrete primer comprises approximately 30% solvent, by weight, which solvent evaporates after application, during curing.

Environmental legislation requires a reduction in the amount of solvents present in polyureas, for example polyurea coatings. Additionally, consumers have become more environmentally aware and the demand for solvent free products has increased.

Reduction in the amount of solvents in polyureas, and compositions for forming polyureas, has been achieved by using lower viscosity raw materials. For example, hexamethylene diisocyanate (HDI) isocyanate trimers with a viscosity of approximately 700 mPas have replaced those having viscosities of approximately 2500 mPas or more. Additionally, some suppliers now provide water-based systems.

The strategies aimed at reducing, or removing, the presence of solvents in polyureas (and polyurea precursors) have frequently caused a reduction in the beneficial physical properties of the polyureas. For example, polyurea coatings which are water-based are often less durable than polyurea coatings formed from mixtures including solvents. Additionally, low viscosity components (e.g. hexamethylene diisocyanate (HDI) included in mixtures for forming polyurea coatings) are typically 50% or more expensive than corresponding high viscosity components.

Some known polyurea coatings have a reduced amount of solvent compared to historic products. However, the available polyurea coatings still present health and safety, and environmental, problems and are dangerous to use in enclosed areas and/or where food is present.

Polyurea coatings are typically formed by mixing together a resin component and an isocyanate (hardener) component. The two components react together readily and are only mixed at the time the polyurea coating is applied, for example to a surface. Typically, the isocyanate component is highly viscous and includes some solvent. The resin component is typically less viscous than the isocyanate component and can optionally include some solvent.

It would be beneficial to reduce, or remove, the presence of solvents in polyureas, for example in polyurea coatings.

### SUMMARY OF THE INVENTION

The present invention discloses a two component composition for forming a polyurea where the two components are substantially solvent free.

Aspects of the present invention are set out in the following clauses:

1. A composition for forming a polyurea, the composition comprising:
an isocyanate;
a resin, the resin comprising: one or more difunctional and/or one or more multifunctional hindered amines; and,
a cyclic alkylene carbonate;
wherein the composition comprises less than 1 weight % solvent.

2. The composition of clause 1, wherein: the isocyanate comprises the cyclic alkylene carbonate; the resin comprises the cyclic alkylene carbonate; or, both the isocyanate and the resin comprise the cyclic alkylene carbonate.

3. The composition of clause 1 or clause 2, wherein the cyclic alkylene carbonate is ethylene carbonate, propylene carbonate, butylene carbonate, dimethyl carbonate or glycerol carbonate, or a mixture of any two, three, four or five of these cyclic alkylene carbonates.

4. The composition of any one of clauses 1 to 3, wherein the composition comprises from 5 weight % to 50 weight % cyclic alkylene carbonate.

5. The composition of any one of clauses 1 to 4, wherein the composition comprises: from 10 weight % to 40 weight % cyclic alkylene carbonate; or, from 15 weight % to 40 weight % cyclic alkylene carbonate; or, from 20 weight % to 30 weight % cyclic alkylene carbonate.

6. The composition of any one of clauses 1 to 5, wherein the composition further comprises a polyol; optionally, wherein the polyol is included with the resin and not the isocyanate prior to forming the composition.

7. The composition of clause 6, wherein the composition comprises a ratio of polyol to amine of:
from: polyol at 0.5 parts by weight (or 10 parts by weight), to, one or more difunctional and/or one or more multifunctional hindered amines at 99.5 parts by weight (or 90 parts by weight),
to: polyol at 50 parts by weight, to, one or more difunctional and/or one or more multifunctional hindered amines at 50 parts by weight.

8. The composition according to any one of clauses 1 to 7, wherein the composition comprises: less than 0.5 weight % solvent; or, less than 0.1 weight % solvent; or, less than 0.01 weight % solvent; or, less than 0.001 weight % solvent; or, 0 weight % solvent.

9. The composition according to any one of clauses 1 to 8 wherein solvent refers to any one, two, three, four or five of: methyl proxitol acetate, butyl acetate, methyl isobutyl ketone, xylene and dibasic ester.

10. The composition according to any one of clauses 1 to 9, wherein the isocyanate is any one, two, three, four or five of: hexamethylene diisocyanate (HDI), isophorone diisocyanate (IPDI), tetramethylxylene diisocyanate (TMXDI), methylene diphenyl diisocyanate (MDI) and/or toluene diisocyanate (TDI); optionally, wherein the isocyanate is one or more of: Tolonate™ HDT, Tolonate™ HDT-LV, Tolonate™ HDT-LV2, BASONAT® HI 100 NG, BASONAT® HI 2000 NG, DESMODUR® ultra N3300, and/or DESMODUR® ultra N3600.

11. The composition according to any one of clauses 1 to 10, wherein the one or more difunctional and/or one or more multifunctional hindered amines is a polyaspartic resin; optionally, wherein the polyaspartic resin is one or more of: Feiyang™ Feispartic F420, Desmophen® NH 1220, Desmophen® NH 1420, Desmophen® NH 1442, Teraspartic™ 277, Teraspartic™ 292, and/or Teraspartic™ 230.

12. The composition according to any one of clauses 6 to 11, wherein the polyol is one or more of: poly(tetramethylene ether)glycol, polycaprolactone diols, polycaprolactone triols, polycaprolactone tetrols, glycerol, glycerol carbonate, trimethylolpropane, pentaerythritol, 1,4-butanediol and/or 1,6-hexanediol; optionally, wherein the polyol is poly(tetramethylene ether)glycol.

13. The composition according to any one of clauses 1 to 12, wherein the composition is a two part composition, the isocyanate and the resin being separate prior to formation of the polyurea.

14. The composition according to any one of clauses 1 to 13, wherein the composition comprises, or consists, of:
from 5 to 60 weight % isocyanate;
from 30 to 65 weight % resin, and,
from 10 to 30 weight % cyclic alkylene carbonate;
wherein the composition comprises less than 1 weight % solvent.

15. The composition of clause 14, wherein the weight % ratio of isocyanate to resin is from:
2 parts by weight resin to 1 part by weight isocyanate; to,
6 parts by weight resin to 5 parts by weight isocyanate.

16. The composition of clause 14 or clause 15, wherein the composition further comprises, or further consists of, less than 5 weight % additives; optionally, wherein the additives are one or more of: air release agents, wetting agents and/or moisture scavengers.

17. A kit for forming a polyurea, the kit comprising:
a first receptacle comprising an isocyanate; and,
a second receptacle comprising a resin, the resin comprising: one or more difunctional and/or one or more multifunctional hindered amines; and,
the first receptacle, the second receptacle, or, both the first receptacle and the second receptacle, comprising a cyclic alkylene carbonate;
wherein the first receptacle and the second receptacle each comprise less than 1 weight % solvent.

18. The kit of clause 17, wherein: the isocyanate comprises the cyclic alkylene carbonate; the resin comprises the cyclic alkylene carbonate; or, both the isocyanate and the resin comprise the cyclic alkylene carbonate.

19. The kit of clause 17 or clause 18, wherein the cyclic alkylene carbonate is ethylene carbonate, propylene carbonate, butylene carbonate, dimethyl carbonate or glycerol carbonate, or a mixture of any two, three, four or five of these cyclic alkylene carbonates.

20. The kit of any one of clauses 17 to 19, wherein the kit comprises from 5 weight % to 50 weight % cyclic alkylene carbonate.

21. The kit of any one of clauses 17 to 20, wherein the kit comprises: from 10 weight % to 40 weight % cyclic alkylene carbonate; or, from 15 weight % to 40 weight % cyclic alkylene carbonate; or, from 20 weight % to 30 weight % cyclic alkylene carbonate.

22. The kit of any one of clauses 17 to 21, wherein the kit further comprises a polyol.

23. The kit of clause 22, wherein the kit comprises a ratio of polyol to amine of:
from: polyol at 0.5 parts by weight (or 10 parts by weight), to, one or more difunctional and/or one or more multifunctional hindered amines at 99.5 parts by weight (or 90 parts by weight),
to: polyol at 50 parts by weight, to, one or more difunctional and/or one or more multifunctional hindered amines at 50 parts by weight.

24. The kit according to any one of clauses 17 to 23, wherein the composition comprises: less than 0.5 weight % solvent; or, less than 0.1 weight % solvent; or, less than 0.01 weight % solvent; or, less than 0.001 weight % solvent; or, 0 weight % solvent.

25. The kit according to any one of clauses 17 to 24, wherein solvent refers to any one, two, three, four or five of: methyl proxitol acetate, butyl acetate, methyl isobutyl ketone, xylene and dibasic ester.

26. The kit according to any one of clauses 17 to 25, wherein the isocyanate is any one, two, three, four or five of: hexamethylene diisocyanate (HDI), isophorone diisocyanate (IPDI), tetramethylxylene diisocyanate (TMXDI), methylene diphenyl diisocyanate (MDI) and/or toluene diisocyanate (TDI); optionally, wherein the isocyanate is one or more of: Tolonate™ HDT, Tolonate™ HDT-LV, Tolonate™ HDT-LV2, BASONAT® HI 100 NG, BASONAT® HI 2000 NG, DESMODUR® ultra N3300, and/or DESMODUR® ultra N3600.

27. The kit according to any one of clauses 17 to 26, wherein the one or more difunctional and/or one or more multifunctional hindered amines is a polyaspartic resin; optionally, wherein the polyaspartic resin is one or more of: Feiyang™ Feispartic F420, Desmophen® NH 1220, Desmophen® NH 1420, Desmophen® NH 1442, Teraspartic™ 277, Teraspartic™ 292, and/or Teraspartic™ 230.

28. The kit according to any one of clauses 22 to 27, wherein the polyol is one or more of: poly(tetramethylene ether)glycol, polycaprolactone diols, polycaprolactone triols, polycaprolactone tetrols, glycerol, glycerol carbonate, trimethylolpropane, pentaerythritol, 1,4-butanediol and/or 1,6-hexanediol; optionally, wherein the polyol is poly(tetramethylene ether)glycol.

29. The kit according to any one of clauses 17 to 28, wherein the first receptacle and the second receptacle are not in fluid communication prior to formation of the polyurea.

30. The kit according to any one of clauses 17 to 29, wherein the kit comprises, or consists, of:
from 5 to 60 weight % isocyanate;
from 30 to 65 weight % resin, and,
from 10 to 30 weight % cyclic alkylene carbonate;
wherein the composition comprises less than 1 weight % solvent.

31. The kit of clause 30, wherein the weight % ratio of isocyanate to resin is from:
2 parts by weight resin to 1 part by weight isocyanate; to,
6 parts by weight resin to 5 parts by weight isocyanate.

32. The kit of clause 30 or clause 31, wherein the kit further comprises, or further consists of, less than 5 weight % additives; optionally, wherein the additives are one or more of: air release agents, wetting agents and/or moisture scavengers.

33. A method of forming a polyurea, the method comprising combining:
an isocyanate;
a resin, the resin comprising: one or more difunctional and/or one or more multifunctional hindered amines; and,
a cyclic alkylene carbonate;
wherein the isocyanate, the resin and the cyclic alkylene carbonate each comprise less than 1 weight % solvent.

34. The method of clause 33, wherein: the isocyanate comprises the cyclic alkylene carbonate; the resin comprises the cyclic alkylene carbonate; or, both the isocyanate and the resin comprise the cyclic alkylene carbonate.

35. The method of clause 33 or clause 34, wherein the cyclic alkylene carbonate is ethylene carbonate, propylene carbonate, butylene carbonate, dimethyl carbonate or glycerol carbonate, or a mixture of any two, three, four or five of these cyclic alkylene carbonates.

36. The method of any one of clauses 33 to 35, wherein the method comprises combining from 5 weight % to 50 weight % cyclic alkylene carbonate.

37. The method of any one of clauses 33 to 36, wherein the method comprises combining: from 10 weight % to 40 weight % cyclic alkylene carbonate; or, from 15 weight % to 40 weight % cyclic alkylene carbonate; or, from 20 weight % to 30 weight % cyclic alkylene carbonate.

38. The method of any one of clauses 33 to 37, wherein the method further comprises combining a polyol with the other components; optionally, with the resin components.

39. The method of clause 38, wherein the method comprises combining a ratio of polyol to amine of:
from: polyol at 0.5 parts by weight (or 10 parts by weight), to, one or more difunctional and/or one or more multifunctional hindered amines at 99.5 parts by weight (or 90 parts by weight),
to: polyol at 50 parts by weight, to, one or more difunctional and/or one or more multifunctional hindered amines at 50 parts by weight.

40. The method according to any one of clauses 33 to 39, wherein the method comprises combining: less than 0.5 weight % solvent; or, less than 0.1 weight % solvent; or, less than 0.01 weight % solvent; or, less than 0.001 weight % solvent; or, 0 weight % solvent.

41. The method according to any one of clauses 33 to 40 wherein solvent refers to any one, two, three, four or five of: methyl proxitol acetate, butyl acetate, methyl isobutyl ketone, xylene and dibasic ester.

42. The method according to any one of clauses 33 to 41, wherein the isocyanate is any one, two, three, four or five of: hexamethylene diisocyanate (HDI), isophorone diisocyanate (IPDI), tetramethylxylene diisocyanate (TMXDI), methylene diphenyl diisocyanate (MDI) and/or toluene diisocyanate (TDI); optionally, wherein the isocyanate is one or more of: Tolonate™ HDT, Tolonate™ HDT-LV, Tolonate™ HDT-LV2, BASONAT® HI 100 NG, BASONAT® HI 2000 NG, DESMODUR® ultra N3300, and/or DESMODUR® ultra N3600.

43. The method according to any one of clauses 33 to 42, wherein the one or more difunctional and/or one or more multifunctional hindered amines is a polyaspartic resin; optionally, wherein the polyaspartic resin is one or more of: Feiyang™ Feispartic F420, Desmophen® NH 1220, Desmophen® NH 1420, Desmophen® NH 1442, Teraspartic™ 277, Teraspartic™ 292, and/or Teraspartic™ 230.

44. The method according to any one of clauses 38 to 43, wherein the polyol is one or more of: poly(tetramethylene ether)glycol, polycaprolactone diols, polycaprolactone triols, polycaprolactone tetrols, glycerol, glycerol carbonate, trimethyloIpropane, pentaerythritol, 1,4-butanediol and/or 1,6-hexanediol; optionally, wherein the polyol is poly(tetramethylene ether)glycol.

45. The method according to any one of clauses 38 to 44, wherein the isocyanate and the resin are separate prior to formation of the polyurea.

46. The method according to any one of clauses 33 to 45, wherein the method comprises, or consists of, combining:
from 5 to 60 weight % isocyanate;
from 30 to 65 weight % resin, and,
from 10 to 30 weight % cyclic alkylene carbonate;
wherein the composition comprises less than 1 weight % solvent.

47. The method of clause 46, wherein the weight % ratio of isocyanate to resin is from:
2 parts by weight resin to 1 part by weight isocyanate; to,
6 parts by weight resin to 5 parts by weight isocyanate.

48. The method of clause 46 or clause 47, wherein the method further comprises, or further consists of combining, less than 5 weight % additives; optionally, wherein the additives are one or more of: air release agents, wetting agents and/or moisture scavengers.

49. A method of forming a surface, the method comprising forming a polyurea according to any one of clauses 33 to 48 on top of a floor; optionally, wherein the floor is a cementitious floor.

50. A polyurea obtained by, or obtainable by, the method of any one of clauses 33 to 48.

51. A surface obtained by, or obtainable by, the method of clause 49.

### BRIEF DESCRIPTION OF THE FIGURES

Embodiments of the invention are described below with reference to the accompanying drawings. The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1: Graph showing the effect of increasing percentages of propylene carbonate in Feispartic F420 polyaspartic resin cured with Tolonate™ HDT isocyanate.

FIG. 2: Graph showing the effect of increasing percentages of PTMEG polyol in Feispartic F420 polyaspartic resin and propylene carbonate cured with Tolonate™ HDT isocyanate.

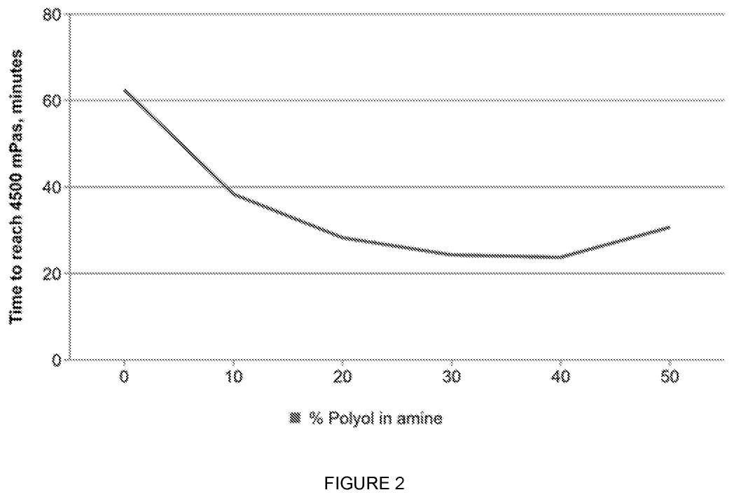

### DETAILED DESCRIPTION OF THE INVENTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred systems and methods are now described.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Some of the terms used to describe the present invention are set out below:

“Polyurea” refers to an elastomer formed by the reaction between one or more isocyanate components and one or more resin components (optionally, wherein the resin components are amine terminated resin components). A polyurea can have the formula (—C(═O)—NH—R—NH—C(═O)—NH—R′—NH—)ₙ, where n is any integer.

“Isocyanate” and “isocyanate component” refers to a compound of the formula OCN—R—NCO. An isocyanate component may contain any difunctional or multifunctional aliphatic or aromatic isocyanate, or their respective prepolymers. In some examples, an isocyanate component includes one or more cyclic alkylene carbonates. Non-limiting examples of isocyanate components included hexamethylene diisocyanate (HDI), isophorone diisocyanate (IPDI), tetramethylxylene diisocyanate (TMXDI), methylene diphenyl diisocyanate (MDI) and toluene diisocyanate (TDI). Non-limiting examples of commercially available isocyanates are: Tolonate™ HDT Isocyanate (having a viscosity of 2,400 mPas), as currently sold by Vencorex™ Chemicals; Tolonate™ HDT-LV (having a viscosity of 1,200 mPas), as currently sold by Vencorex™ Chemicals; Tolonate™ HDT-LV2 (having a viscosity of 600 Mpas), as currently sold by Vencorex™ Chemicals; BASONAT® HI 100 NG is an HDI trimer (having a viscosity of from 2,500 to 4,000 mPas), as currently sold by BASF™; BASONAT® HI 2000 NG is an HDI trimer (having a viscosity of from 900 to 1,500 mPas), as currently sold by BASF; DESMODUR® ultra N3300 is an HDI trimer (having a viscosity of 3,000 mPas), as currently sold by Covestro Deutschland AG; DESMODUR® ultra N3600 is an HDI trimer (having a viscosity of 1,200 mPas), as currently sold by Covestro Deutschland AG.

“Resin” and “resin component” refers to a mixture comprising one or more difunctional and/or one or more multifunctional hindered amines of the formula H₂N—R′—NH₂. The “resin” or “resin component” can be a polyaspartic resin. In some examples, the resin component includes one or more cyclic alkylene carbonates. The “resin” or “resin component” optionally further comprises one or more polyol compounds; the polyol compounds comprising two, three, four or more primary hydroxyl groups. Non-limiting examples of commercially available resins are: Feiyang™ Feispartic F420 polyaspartic resin, as currently sold by Shenzhen Feiyang Protech Corp., Ltd.; Desmophen® NH 1220, as currently sold by Covestro Deutschland AG; Desmophen® NH 1420, as currently sold by Covestro Deutschland AG; Desmophen® NH 1442 as currently sold by Covestro Deutschland AG; Teraspartic™ 277, as currently sold by Pflaumer Brothers Inc., New Jersey, USA; Teraspartic™ 292, as currently sold by Pflaumer Brothers Inc., New Jersey, USA; and, Teraspartic™ 230, as currently sold by Pflaumer Brothers Inc., New Jersey, USA.

“Cyclic alkylene carbonate” refers to cyclic organic esters formed from the reaction of ethylene oxide, propylene and/or butylene oxide, and carbon dioxide. Cyclic alkylene carbonates are stable for several years in sterically hindered amines such as polyaspartic resins and in isocyanates (including hexamethylene diisocyanate (HDI), isophorone diisocyanate (IPDI), tetramethylxylene diisocyanate (TMXDI), methylene diphenyl diisocyanate (MDI) and toluene diisocyanate (TDI)). Examples of cyclic alkylene carbonates include, but are not limited to, ethylene carbonate, propylene carbonate, butylene carbonate, dimethyl carbonate and glycerol carbonate.

“Polyol” refers to an organic compound with multiple hydroxyl (—OH) groups, which organic molecule does not include any other functional groups. In polymer chemistry, polyols often act as crosslinking agents. A non-limiting example of a polyol is poly(tetramethylene ether)glycol. Other non-limiting examples of a polyol include polycaprolactone diols, polycaprolactone triols, polycaprolactone tetrols, glycerol, glycerol carbonate, trimethylolpropane, pentaerythritol, 1,4-butanediol and/or 1,6-hexanediol.

“Aliphatic” refers to hydrocarbons (which can be linear, branched, or cyclic), wherein the hydrocarbon does not have any pi-systems obeying Hickel's rule. Examples of aliphatic groups include alkyl groups, haloalkyl groups, cycloalkyl groups, alkenyl groups and alkynyl groups.

“Aromatic” refers to a hydrocarbons (which can be linear, branched, or cyclic), wherein the hydrocarbon does have one or more pi-systems obeying Hickel's rule. Examples of aromatic groups include aryl groups.

As used herein, any “R” group(s) such as, without limitation, R and R′ represent substituents that can be attached to the indicated atom. An R group may be substituted or unsubstituted.

As used herein, “alkyl” refers to a straight or branched hydrocarbon chain that comprises a fully saturated (no double or triple bonds) hydrocarbon group. The alkyl group may have 1 to 26 carbon atoms (whenever it appears herein, a numerical range such as “1 to 26” refers to each integer in the given range; e.g. “1 to 26 carbon atoms” means that the alkyl group may consist of 1 carbon atom, 2 carbon atoms, 3 carbon atoms, 4 carbon atoms, 5 carbon atom, 6 carbon atoms, 7 carbon atoms, 8 carbon atoms, 9 carbon atom, 10 carbon atoms, 11 carbon atoms, 12 carbon atoms, 13 carbon atoms, 14 carbon atoms, 15 carbon atoms, 16 carbon atoms, 17 carbon atoms, 18 carbon atoms, 19 carbon atoms, 20 carbon atoms, 21 carbon atoms, 22 carbon atoms, 23 carbon atoms, 24 carbon atoms, 25 carbon atoms or 26 carbon atoms, although the present definition also covers the occurrence of the term “alkyl” where no numerical range is designated). The alkyl group may also be a medium size alkyl having from 1 to 10 carbon atoms. The alkyl group could also be a lower alkyl having from 1 to 6 carbon atoms. The alkyl group of the compounds may be designated as “C₁-C₆ alkyl” or similar designations. By way of example only, “C₁-C₆ alkyl” indicates that there are one to six carbon atoms in the alkyl chain, i.e. the alkyl chain is selected from methyl, ethyl, propyl, iso-propyl, n-butyl, iso-butyl, sec-butyl, and t-butyl, pentyl (straight and branched) and hexyl (straight and branched). Typical alkyl groups include, but are in no way limited to, methyl, ethyl, propyl, isopropyl, butyl, isobutyl, tertiary butyl, pentyl (straight and branched) and hexyl (straight and branched). The alkyl group may be mono- or polysubstituted or unsubstituted. Typical substituents can be selected from —OH, —O—C₁₋₆ (optionally halo, e.g. —F, —Cl, —Br or —I)alkyl, —SH, —S—C₁₋₆ alkyl, —N₃, —NO₂, -halo (e.g. —F, —Cl, —Br or —I), —COOH, and/or —COOR₂ (wherein R₂ is substituted or unsubstituted C₁-C₂₆ alkyl).

As used herein, “haloalkyl”, for example “chloroalkyl”, refers to a straight or branched hydrocarbon chain that comprises a fully saturated (no double or triple bonds) hydrocarbon group and at least one halogen atom, for example chlorine atom in the case of “chloroalkyl”, (optionally, one, two, three, four, five or six, or more, halo atoms, for example chlorine atoms). The term “haloalkyl” encompasses fluoroalkyl, chloroalkyl, bromoalkyl and iodoalkyl. The haloalkyl group, for example chloroalkyl group, may have 1 to 26 carbon atoms (whenever it appears herein, a numerical range such as “1 to 26” refers to each integer in the given range; e.g. “1 to 26 carbon atoms” means that the alkyl group may consist of 1 carbon atom, 2 carbon atoms, 3 carbon atoms, 4 carbon atoms, 5 carbon atom, 6 carbon atoms, 7 carbon atoms, 8 carbon atoms, 9 carbon atom, 10 carbon atoms, 11 carbon atoms, 12 carbon atoms, 13 carbon atoms, 14 carbon atoms, 15 carbon atoms, 16 carbon atoms, 17 carbon atoms, 18 carbon atoms, 19 carbon atoms, 20 carbon atoms, 21 carbon atoms, 22 carbon atoms, 23 carbon atoms, 24 carbon atoms, 25 carbon atoms or 26 carbon atoms, although the present definition also covers the occurrence of the term “alkyl” where no numerical range is designated). The chloroalkyl group may also be a medium size chloroalkyl having from 1 to 10 carbon atoms. The chloroalkyl group could also be a lower chloroalkyl having from 1 to 6 carbon atoms. The chloroalkyl group of the compounds may be designated as “C₁-C₆ chloroalkyl” or similar designations. By way of example only, “C₁-C₆ chloroalkyl” indicates that there are one to six carbon atoms in the alkyl chain, i.e. the alkyl chain is selected from, each having at least one chlorine atom, chloromethyl, chloroethyl, chloropropyl, chloro-iso-propyl, chloro-n-butyl, chloro-iso-butyl, chloro-sec-butyl, and chloro-t-butyl, chloropentyl (straight and branched) and chlorohexyl (straight and branched). Typical chloroalkyl groups include, but are in no way limited to, chloromethyl, chloroethyl, chloropropyl, chloroisopropyl, chlorobutyl, chloroisobutyl, chloro-tertiary butyl, chloropentyl (straight and branched) and chlorohexyl (straight and branched). Analogously, respective fluoroalkyl, bromoalkyl or iodoalkyl groups are included within this definition of haloalkyl. The haloalkyl group, for example chloroalkyl group, may be mono- or polysubstituted or unsubstituted. Typical substituents can be selected from —OH, —O—C₁₋₆ (optionally halo, e.g. —F, —Cl, —Br or —I)alkyl, —SH, —S—C₁₋₆ alkyl, —N₃, —NO₂, -halo (e.g. —F, —Cl, —Br or —I), —COOH, and/or —COOR₂ (wherein R₂ is substituted or unsubstituted C₁-C₂₆ alkyl).

As used herein, “cycloalkyl” refers to a completely saturated (no double or triple bonds) mono- or multi-cyclic hydrocarbon ring system. When composed of two or more rings, the rings may be joined together in a fused fashion. Cycloalkyl groups can contain 3 to 10 atoms in the ring(s) or 3 to 8 atoms in the ring(s). A cycloalkyl group may be unsubstituted or substituted. Typical cycloalkyl groups include, but are in no way limited to, cyclopropyl, cyclobutyl, cyclopentyl, cyclohexyl, cycloheptyl and cyclooctyl. Typical substituents can be selected from —OH, —O—C₁₋₆ (optionally halo, e.g. —F, —Cl, —Br or —I)alkyl, —SH, —S—C₁₋₆ alkyl, —N₃, —NO₂, -halo (e.g. —F, —Cl, —Br or —I), —COOH, and/or —COOR₂ (wherein R₂ is substituted or unsubstituted C₁-C₂₆ alkyl).

As used herein, “aryl” refers to a carbocyclic (all carbon) mono-cyclic or multi-cyclic aromatic ring system (including fused ring systems where two carbocyclic rings share a chemical bond) that has a fully delocalized pi-electron system throughout all the rings. The number of carbon atoms in an aryl group can vary. For example, the aryl group can be a C₆-C₁₄ aryl group, a C₆-C₁₀ aryl group, or a C₆ aryl group. Examples of aryl groups include, but are not limited to, benzene, naphthalene and azulene. An aryl group may be mono- or polysubstituted or unsubstituted. Typical substituents can be selected from —OH, —O—C₁₋₆ (optionally halo, e.g. —F, —Cl, —Br or —I)alkyl, —SH, —S—C₁₋₆ alkyl, —N₃, —NO₂, -halo (e.g. —F, —Cl, —Br or —I), —COOH, and/or —COOR₂ (wherein R₂ is substituted or unsubstituted C₁-C₂₆ alkyl).

As used herein, “alkenyl” refers to a straight or branched hydrocarbon chain containing one or more double bonds. The alkenyl group may have 2 to 20 carbon atoms, although the present definition also covers the occurrence of the term “alkenyl” where no numerical range is designated. The alkenyl group may also be a medium size alkenyl having 2 to 9 carbon atoms. The alkenyl group could also be a lower alkenyl having 2 to 4 carbon atoms. The alkenyl group may be designated as “C₂₋₄ alkenyl” or similar designations. By way of example only, “C₂₋₄ alkenyl” indicates that there are two to four carbon atoms in the alkenyl chain, i.e. the alkenyl chain is selected from the group consisting of ethenyl, propen-1-yl, propen-2-yl, propen-3-yl, buten-1-yl, buten-2-yl, buten-3-yl, buten-4-yl, 1-methyl-propen-1-yl, 2-methyl-propen-1-yl, 1-ethyl-ethen-1-yl, 2-methyl-propen-3-yl, buta-1,3-dienyl, buta-1,2,-dienyl, and buta-1,2-dien-4-yl. Typical alkenyl groups include, but are in no way limited to, ethenyl, propenyl, butenyl, pentenyl, and hexenyl, and the like. An alkenyl group may be mono- or polysubstituted or unsubstituted. Typical substituents can be selected from —OH, —O—C₁₋₆ (optionally halo, e.g. —F, —Cl, —Br or —I)alkyl, —SH, —S—C₁₋₆ alkyl, —N₃, —NO₂, -halo (e.g. —F, —Cl, —Br or —I), —COOH, and/or —COOR₂ (wherein R₂ is substituted or unsubstituted C₁-C₂₆ alkyl).

As used herein, “alkynyl” refers to a straight or branched hydrocarbon chain containing one or more triple bonds. The alkynyl group may have 2 to 20 carbon atoms, although the present definition also covers the occurrence of the term “alkynyl” where no numerical range is designated. The alkynyl group may also be a medium size alkynyl having 2 to 9 carbon atoms. The alkynyl group could also be a lower alkynyl having 2 to 4 carbon atoms. The alkynyl group may be designated as “C₂₋₄ alkynyl” or similar designations. By way of example only, “C₂₋₄ alkynyl” indicates that there are two to four carbon atoms in the alkynyl chain, i.e. the alkynyl chain is selected from the group consisting of ethynyl, propyn-1-yl, propyn-2-yl, butyn-1-yl, butyn-3-yl, butyn-4-yl, and 2-butynyl. Typical alkynyl groups include, but are in no way limited to, ethynyl, propynyl, butynyl, pentynyl, and hexynyl, and the like. An alkynyl group may be mono- or polysubstituted or unsubstituted. Typical substituents can be selected from —OH, —O—C₁₋₆ (optionally halo, e.g. —F, —Cl, —Br or —I)alkyl, —SH, —S—C₁₋₆ alkyl, —N₃, —NO₂, -halo (e.g. —F, —Cl, —Br or —I), —COOH, and/or —COOR₂ (wherein R₂ is substituted or unsubstituted C₁-C₂₆ alkyl).

“Prepolymer” refers to a monomer or system of monomers that have been reacted together to an intermediate molecular mass state (i.e. not the final polymeric form). A prepolymer is capable of further polymerisation by reactive groups to a fully cured, high molecular weight state.

### Formation of Polyureas

According to the present invention, there is provided a composition for forming a polyurea, the composition comprising:
an isocyanate;
a resin, the resin comprising: one or more difunctional and/or one or more multifunctional hindered amines; and,
a cyclic alkylene carbonate;
wherein the composition comprises less than 1 weight % solvent.

The present inventor surprisingly discovered that removing solvent and replacing the solvent (in whole or in part) with a cyclic alkylene carbonate in the resin, in the isocyanate, or in the resin and the isocyanate, leads to the solvent-free formation of polyureas. The cyclic alkylene carbonate acts to reduce the viscosity of the mixture and also participates in the reaction between the resin component and the isocyanate component. Without wishing to be bound by theory, the cyclic alkylene carbonate reacts catalytically to improve the efficiency of the formation of the polyurea. Without wishing to be bound by theory, it appears that the urea group that is formed by the reaction of the hindered amine with the isocyanate acts as a catalyst which causes the alkylene carbonate to react into the polymer matrix.

The present inventor further discovered that the optional addition of one or more polyols to the resin, the isocyanate, or the resin and the isocyanate, leads to polyureas with beneficial properties. Without wishing to be bound by theory, the addition of a polyol is believed to form cross-links in the polyurea and/or to form polyurethanes within the reaction mixture which further modify the properties of the reaction product.

Polyureas according to the present invention optionally include one or more additives selected from the group consisting of: air release agents, wetting agents and moisture scavengers. These additives are added depending on the desired properties of the polyureas.

### Examples

### Materials Used in the Examples

### Feiyang™ Feispartic F420 Polyaspartic Resin

The chemical name of this resin is N,N′-(Methylenedi-4,1-cyclohexanediyl)bisaspartic acid tetraethyl ester. This polyaspartic resin has the CAS registry number 136210-30-5. Feiyang™ F420 is a solvent-free amine-functional resin with this chemical formula currently sold by Shenzhen Feiyang Protech Corp., Ltd.

### Propylene Carbonate

Propylene carbonate is an organic compound with the formula:

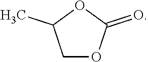

Propylene carbonate has the CAS number 108-32-7. The propylene carbonate used in the examples was purchased from Megachem Ltd., Caldicot, UK.

### Tolonate™ HDT Isocyanate

Tolonate™ HDT Isocyanate is a medium viscosity, solvent-free aliphatic polyisocyanate. Tolonate™ HDT Isocyanate is currently sold by Vencorex™ Chemicals. This isocyanate has a viscosity of 2,400 mPas, and is based on hexamethylene diisocyanate trimer (HDI homopolymer).

Poly(tetramethylene ether)glycol

Poly(tetramethylene ether)glycol, also known as polytetrahydrofuran, is a chemical compound with the formula (C₄H₈O)ₙOH₂. It can be viewed as a polymer of tetrahydrofuran, or as a polyether derived from 1,4-butanediol. Poly(tetramethylene ether)glycol has the CAS number 25190-06-1. The poly(tetramethylene ether)glycol used in the examples was purchased from Gantrade Europe Ltd., UK.

### Experiment 1

### Objective

To determine the effect of increasing amounts of an alkylene carbonate in a resin composition containing Feiyang™ F420 polyaspartic resin cured with Tolonate™ HDT isocyanate.

### Method

The amount of Propylene Carbonate (PC) was increased in 10% steps from 0 to 60 parts (by weight) per 100 parts (by weight) of total resin.

In each case, the following steps were carried out:
1. The resin was weighed into a mixing pot at 25° C. and atmospheric pressure.
2. The propylene carbonate was weighed into the mixing pot using a syringe.
3. The Tolonate™ HDT was weighed into the mixing pot also using a syringe.
4. The mixture was mixed using a medical tongue depressor.
5. An Elcometer® 2300 RV1-L viscometer was used to measure viscosity with a L2 spindle at 6 rpm. At this setting, the viscometer could measure viscosities in the range from 300 to 5,000 mPas.

### Results

TABLE 1A
Effect of increasing amount of propylene carbonate.

| | | | | | |
|---|---|---|---|---|---|
| Feiyang F420 polyaspartic | Grams | 100 | 90 | 80 | 70 |
| resin | | | | | |
| Propylene carbonate | Grams | 0 | 10 | 20 | 30 |
| Tolonate ™ HDT Isocyanate | Grams | 51.7 | 48.4 | 39.8 | 40.9 |
| Initial viscosity | Mpas | 3820 | 1750 | 615 | 360 |
| Time to 4000 mPas | minutes | 1.6 | 9.6 | 20.8 | 27.6 |
| Gel time | minutes | 47 | 55 | 62 | 90 |
| Shore A hardness | | 97 | 99 | 99 | 77 |
| Weight % Propylene carbonate | | 0.00% | 6.74% | 14.31% | 21.29% |
| in the total formulation | | | | | |

TABLE 1B
Effect of increasing amount of propylene carbonate.

| | | | | |
|---|---|---|---|---|
| Feiyang F420 polyaspartic | Grams | 60 | 50 | 40 |
| resin | | | | |
| Propylene carbonate | Grams | 40 | 50 | 60 |
| Tolonate ™ HDT | Grams | 32.6 | 32 | 26.8 |
| Isocyanate | | | | |
| Initial viscosity | Mpas | <300 | <300 | <300 |
| Time to 4000 mPas | minutes | 46 | 63 | 87.5 |
| Gel time | minutes | 119 | 142 | 195 |
| Shore A hardness | | 64.5 | 50 | 32 |
| Weight % Propylene | | 30.17% | 37.88% | 47.32% |
| carbonate in the total | | | | |
| formulation | | | | |

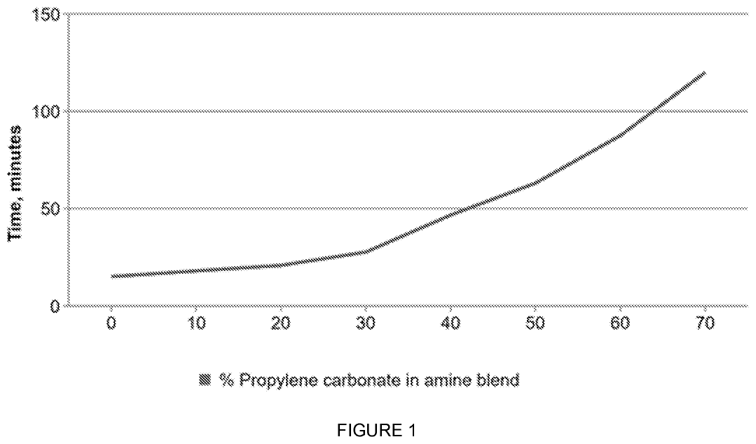

FIG. 1 shows the results from Tables 1A and 1B.

### Observations

Increasing amounts of PC increased the curing time and reduced hardness. Initial hardness is lower than if made without PC. However, the products continue to cure over a few days to become very hard.

The reduced viscosity when using PC (without using solvent) is beneficial. PC does not volatilise, like a conventional solvent, therefore mitigating environmental concerns. There is a lower cost associated with using PC rather than conventional solvents (PC costs £1.50 per kilo compared with more than three times this price for polyaspartic resin or HDT isocyanate).

PC can be made with CO₂ extracted from the atmosphere. Therefore, the use of PC rather than traditional reaction components for forming polyureas comes with the added benefit of reducing net carbon released to the atmosphere.

### Experiment 2

To determine the effect of reducing the amount of amine in the formula and replacing the amine to some extent with a polyol containing primary hydroxyl groups.

### Method

A blend of Poly(tetramethylene ether)glycol (PTMEG) was made with the same average molecular weight as the polyaspartic resin. This was so that the total amount of the ingredients remained constant although their proportions varied throughout the experiment.

The proportions of the F420 resin and the polyol were varied in 10% (by weight) increments

In each case, the following steps were carried out:
1. The resin was weighed into a mixing pot at 25° C. and atmospheric pressure.
2. The PTMEG was weighed into the mixing pot using a syringe.
3. The Tolonate™ HDT was weighed into the mixing pot also using a syringe.
4. The propylene carbonate was weighed into the mixing pot using a syringe.
5. The mixture was mixed using a medical tongue depressor.
6. An Elcometer® 2300 RV1-L viscometer was used to measure viscosity with a L2 spindle at 6 rpm. At this setting, the viscometer could measure viscosities in the range from 300 to 5,000 mPas.

### Results

TABLE 2
Effect of increasing amount of PTMEG (a polyol).

| | 100/0 | 90/10 | 80/20 | 70/30 | 60/40 | 50/50 |
|---|---|---|---|---|---|---|
| Feiyang F420/grams | 100 | 90 | 80 | 70 | 60 | 50 |
| PTMEG blend/grams | 0 | 10 | 20 | 30 | 40 | 50 |
| Tolonate ™ HDT/grams | 68.95 | 68.95 | 68.95 | 68.95 | 68.95 | 68.95 |
| Propylene | 68.95 | 68.95 | 68.95 | 68.95 | 68.95 | 68.95 |
| carbonate/grams | | | | | | |
| Time to | 62.5 | 38.3 | 28.3 | 24.3 | 23.7 | 30.7 |
| 4000 mPas/minutes | | | | | | |

FIG. 1 shows the results from Table 2.

### Observations

Increasing the proportion of polyol in the formulation to 40% (by weight) increased its reactivity and reduced its time to reach 4500 mPas. 4500 mPas was the maximum measured viscosity because at a viscosity higher than 4500 mPas the mixture will be too viscous to apply to a surface.

The samples that contained more than 40% (by weight) polyol failed to fully cure and the sample with 100% polyol remained liquid with a stable viscosity for more than 14 days.

Adding just polyol (and no propylene carbonate) would result in the formation of a polyurethane, which is not the desired product.

By adding propylene carbonate, the speed of hardening reduces, although the product does harden (to the same extent) eventually.

By optionally adding polyols, the product is more elastic and less costly. Many polyols are half the cost of polyaspartic resin.

X Flo-100, currently sold by Vencorex™ Chemicals, is an expensive, slow curing isocyanate said to flexibilise polyureas. Propylene carbonate can be used as a full or partial replacement for X Flo-100 at a fraction of the cost.

### Experiment 3

### Objective

To determine, when a polyol is optionally added, whether it is the % OH in the formulation that accelerates cure rather than the volume of polyol.

It is known that water contamination in polyaspartic coatings will accelerate their cure and can also cause bubbles of CO₂ to form within the coating when water reacts with the isocyanate component.

### Method

Experiment 2-70/30 above with 30% polyol was repeated but with the PTMEG polyol replaced with the following:
a. Glycerol carbonate (supplied by UBE Corporation Europe, S.A.)
b. 1,4 Butane diol+glycerine carbonate 50/50 (supplied as in a. and c.)
c. 1,4 Butane diol (supplied by Gantrade, Europe Ltd.)
d. PTMEG+Butane diol (both materials supplied by Gantrade, Europe Ltd.)
e. Water
f. Polycapralactone triol (supplied by Gantrade, Europe Ltd.)
g. Caradol ET 250-04, a polyoxypropylene triol (supplied by Shell Chemicals)

The quantity of each reagent was calculated to provide a similar percentage of —OH groups in the formulation.

### Results

Experiment 2 with 70/30 (above) repeated with a selection of polyols. The amounts of each were calculated to maintain a constant ratio of 70% amine groups to 30% hydroxyl groups.

TABLE 3
Effect on cure speed of replacing 30% of the
amine groups in Feiyang F420 with various polyols
and curing with Tolonate ™ HDT.

| | Equivalent | | Time to |
|---|---|---|---|
| | weight/ | Hydroxyl | 4,500 mPas/ |
| Polyol | grams | type | minutes |
| Control. 30% PTMEG blend from | 277 | Primary | 24.30 |
| Exp 2 | | | |
| Glycerol carbonate | 118 | Primary | 11.40 |
| Butane diol + glycerine | 81.5 | Primary | 17.50 |
| carbonate | | | |
| Butane diol | 45.06 | Primary | 21.00 |
| PTMEG + Butane diol 50-50 | 172.5 | Primary | 23.10 |
| Water | 9 | Primary | 24.30 |
| Polycaprolactone triol | 183 | Primary | 31.20 |
| Caradol ET 250-04 | 225 | Secondary | 54.50 |
| polyoxypropylene triol | | | |

### Observation

The most potent accelerating effect was observed with glycerol carbonate which provided the added benefit of a cross-linking reaction with the isocyanate curative.

### Example Commercial Composition

The following table details the components in an example commercial composition:

TABLE 4
Example commercial formulation.

| | | parts by |
|---|---|---|
| | | weight |
| RESIN COMPONENT | | |
| Felyang F420 | polyaspartic resin | 100 |
| BYK 1792 | air release and flow agent | 1.5 |
| 3A Molecular sieve | Moisture scavenging agent | 3 |
| | Total resin weight | 104.5 |
| HARDENER COMPONENT | | |
| Tolonate HDT | | 60 |
| Propylene carbonate | | 29 |
| | Total isocyanate weight | 89 |

The extra components compared to the examples above (air release agent and moisture scavenging agent) were included in this commercial coating to ensure that the coating functioned according to the needs of a particular surface. These additives were not included in the experiments detailed above.

Other example commercial compositions according to the present invention comprise, or consist, of:
from 5 to 60 weight % isocyanate;
from 30 to 65 weight % resin, and,
from 10 to 30 weight % cyclic alkylene carbonate;
wherein the composition comprises less than 1 weight % solvent. Example commercial compositions can further comprises, of further consist of, one or more of: air release agents, wetting agents and moisture scavengers. The one or more of: air release agents, wetting agents and moisture scavengers are present at 6 weight % or less in the composition.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A composition for forming a polyurea, the composition comprising:
an isocyanate;
a resin, the resin comprising: one or more difunctional and/or one or more multifunctional hindered amines; and,
a cyclic alkylene carbonate;
wherein the composition comprises less than 1 weight % solvent.

2. The composition of claim 1, wherein: the isocyanate comprises the cyclic alkylene carbonate; the resin comprises the cyclic alkylene carbonate; or, both the isocyanate and the resin comprise the cyclic alkylene carbonate.

3. The composition of claim 1, wherein the cyclic alkylene carbonate is ethylene carbonate, propylene carbonate, butylene carbonate, dimethyl carbonate or glycerol carbonate, or a mixture of any two, three, four or five of these cyclic alkylene carbonates.

4. The composition of claim 1, wherein the composition comprises from 5 weight % to 50 weight % cyclic alkylene carbonate.

5. The composition of claim 1, wherein the composition comprises: from 10 weight % to 40 weight % cyclic alkylene carbonate; or, from 15 weight % to 40 weight % cyclic alkylene carbonate; or, from 20 weight % to 30 weight % cyclic alkylene carbonate.

6. The composition of claim 1, wherein the composition further comprises a polyol; optionally, wherein the polyol is included with the resin and not the isocyanate prior to forming the composition.

7. The composition of claim 6, wherein the composition comprises a ratio of polyol to amine of:
from: polyol at 0.5 parts by weight (or 10 parts by weight), to, one or more difunctional and/or one or more multifunctional hindered amines at 99.5 parts by weight (or 90 parts by weight),
to: polyol at 50 parts by weight, to, one or more difunctional and/or one or more multifunctional hindered amines at 50 parts by weight.

8. The composition of claim 1, wherein the composition comprises: less than 0.5 weight % solvent; or, less than 0.1 weight % solvent; or, less than 0.01 weight % solvent; or, less than 0.001 weight % solvent; or, 0 weight % solvent.

9. The composition of claim 1, wherein solvent refers to any one, two, three, four or five of: methyl proxitol acetate, butyl acetate, methyl isobutyl ketone, xylene and dibasic ester.

10. The composition of claim 1, wherein the isocyanate is any one, two, three, four or five of: hexamethylene diisocyanate (HDI), isophorone diisocyanate (IPDI), tetramethylxylene diisocyanate (TMXDI), methylene diphenyl diisocyanate (MDI) and/or toluene diisocyanate (TDI); optionally, wherein the isocyanate is one or more of: Tolonate™ HDT, Tolonate™ HDT-LV, Tolonate™ HDT-LV2, BASONAT® HI 100 NG, BASONAT® HI 2000 NG, DESMODUR® ultra N3300, and/or DESMODUR® ultra N3600.

11. The composition of claim 1, wherein the one or more difunctional and/or one or more multifunctional hindered amines is a polyaspartic resin; optionally, wherein the polyaspartic resin is one or more of: Feiyang™ Feispartic F420, Desmophen® NH 1220, Desmophen® NH 1420, Desmophen® NH 1442, Teraspartic™ 277, Teraspartic™ 292, and/or Teraspartic™ 230.

12. The composition of claim 6, wherein the polyol is one or more of: poly(tetramethylene ether)glycol, polycaprolactone diols, polycaprolactone triols, polycaprolactone tetrols, glycerol, glycerol carbonate, trimethylolpropane, pentaerythritol, 1,4-butanediol and/or 1,6-hexanediol; optionally, wherein the polyol is poly(tetramethylene ether)glycol.

13. The composition of claim 1, wherein the composition is a two part composition, the isocyanate and the resin being separate prior to formation of the polyurea.

14. The composition of claim 1, wherein the composition comprises, or consists, of:
from 5 to 60 weight % isocyanate;
from 30 to 65 weight % resin, and,
from 10 to 30 weight % cyclic alkylene carbonate;
wherein the composition comprises less than 1 weight % solvent.

15. The composition of claim 14, wherein the weight % ratio of isocyanate to resin is from:
2 parts by weight resin to 1 part by weight isocyanate; to,
6 parts by weight resin to 5 parts by weight isocyanate.

16. The composition of claim 14, wherein the composition further comprises, or further consists of, less than 5 weight % additives; optionally, wherein the additives are one or more of: air release agents, wetting agents and/or moisture scavengers

17. A kit for forming a polyurea, the kit comprising:
a first receptacle comprising an isocyanate; and,
a second receptacle comprising a resin, the resin comprising: one or more difunctional and/or one or more multifunctional hindered amines; and,
the first receptacle, the second receptacle, or, both the first receptacle and the second receptacle, comprising a cyclic alkylene carbonate;
wherein the first receptacle and the second receptacle each comprise less than 1 weight % solvent.

18. A method of forming a polyurea, the method comprising combining:
an isocyanate;
a resin, the resin comprising: one or more difunctional and/or one or more multifunctional hindered amines; and,
a cyclic alkylene carbonate;
wherein the isocyanate, the resin and the cyclic alkylene carbonate each comprise less than 1 weight % solvent.

19. A method of forming a surface, the method comprising forming a polyurea according to claim 18 on top of a floor; optionally, wherein the floor is a cementitious floor.

20. A polyurea obtained by, or obtainable by, the method of claim 18.

21. A surface obtained by, or obtainable by, the method of claim 19.
